(19) United States
(12) Patent Application Publication
(10) Pub. No.: US 2026/0030569 A1
(43) Pub. Date: Jan. 29, 2026

(54) METHOD

(71) Applicant: TOYOTA JIDOSHA KABUSHIKI KAISHA, Toyota-shi (JP)

(72) Inventors: Xunan QIAN, Koto-ku (JP); Kenichiro SUGIHARA, Kounosu-shi (JP); Satoshi NAOI, Machida-shi (JP)

(73) Assignee: TOYOTA JIDOSHA KABUSHIKI KAISHA, Toyota-shi (JP)

(21) Appl. No.: 19/219,072

(22) Filed: May 27, 2025

(30) Foreign Application Priority Data
Jul. 25, 2024 (JP) 2024-120418

(51) Int. Cl. G06Q 10/0631; B60L 53/57; B60L 53/60; B60R 16/033

(52) U.S. Cl. CPC G06Q 10/06311; B60R 16/033; B60L 53/57; B60L 53/60

(57) ABSTRACT

A method is a method performed by an information processing apparatus, the information processing apparatus being used for providing a rush power supply service that dispatches a power supply vehicle to supply power to a vehicle of a user, the method including accepting, from each of a plurality of users, user designation of one or more power supply conditions for requesting power supply to the vehicle, performing processing that includes a prediction step of predicting a date and time at which the one or more power supply conditions pertaining to the user designation are satisfied as a target date and time and a determination step of determining an operation plan for dispatching the power supply vehicle at the target date and time, and repeatedly performing the processing each time the power supply to the vehicle is completed, with respect to the each of the plurality of users.

### CROSS-REFERENCE TO RELATED APPLICATION

This application claims priority to Japanese Patent Application No. 2024-120418 filed on Jul. 25, 2024, the entire contents of which are incorporated herein by reference.

### TECHNICAL FIELD

The present disclosure relates to a method.

### BACKGROUND

Technology for providing power supply services to vehicles exists. For example, Patent Literature (PTL) 1 discloses that upon receiving a rescue request from an EV running out of power requesting power supply to the EV running out of power, a server notifies the rescue request to the vehicle that supports the same standard as the EV running out of power among multiple vehicles that can supply power.

### CITATION LIST

### Patent Literature

PTL 1: JP 2022-139845 A

### SUMMARY

There is room for improvement with respect to technology for providing power supply services to vehicles.

A method according to the present disclosure is a method performed by an information processing apparatus, the information processing apparatus being used for providing a rush power supply service that dispatches a power supply vehicle to supply power to a vehicle of a user, the method including:
accepting, from each of a plurality of users, user designation of one or more power supply conditions for requesting power supply to the vehicle;
performing processing that includes a prediction step of predicting a date and time at which the one or more power supply conditions pertaining to the user designation are satisfied as a target date and time and a determination step of determining an operation plan for dispatching the power supply vehicle at the target date and time; and
repeatedly performing the processing each time the power supply to the vehicle is completed, with respect to the each of the plurality of users.

According to an embodiment of the present disclosure, technology for providing power supply services to vehicles is improved.

### BRIEF DESCRIPTION OF THE DRAWINGS

In the accompanying drawings:

FIG. 1 is a diagram illustrating a schematic configuration of an information processing apparatus according to the present embodiment; and

FIG. 2 is a flowchart illustrating operations of the information processing apparatus according to the present embodiment.

### DETAILED DESCRIPTION

An embodiment of the present disclosure will be described below, with reference to the drawings.

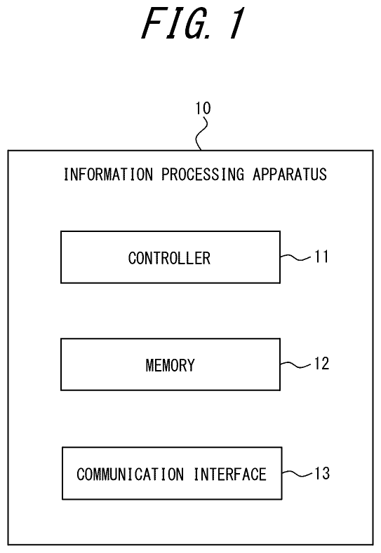

A configuration of an information processing apparatus 10 according to the present embodiment will be described with reference to FIG. 1. The information processing apparatus 10 is, for example, a computer such as a server apparatus or a personal computer (PC), or a general purpose or a dedicated electronic device. The information processing apparatus 10 may be a server that belongs to a cloud computing system. The information processing apparatus 10 provides a rush power supply service that dispatches a power supply vehicle to each user.

First, an outline of the present embodiment will be described, and details thereof will be described later. The information processing apparatus 10 accepts, from each of a plurality of users, user designation of one or more power supply conditions for requesting power supply to a vehicle. The information processing apparatus 10 performs processing that includes a prediction step of predicting a date and time at which the one or more power supply conditions pertaining to the user designation are satisfied as a target date and time and a determination step of determining an operation plan for dispatching a power supply vehicle at the target date and time. The information processing apparatus 10 repeatedly performs the processing each time the power supply to the vehicle is completed, with respect to the each of the plurality of users.

According to the present embodiment, the user only needs to predetermine the power supply conditions, and the user can receive a power supply service each time the date and time at which the power supply conditions are predicted to be satisfied. This reduces the burden on the user compared to, for example, requiring the user to request power supply to the vehicle each time. For the operator of the rush power supply service, the date and time when power should be supplied to each user's vehicle is automatically predicted. This improves the predictability of operation plans for dispatching power supply vehicles and enables efficient resource allocation. Thus, technology for providing power supply services to vehicles can be improved.

A configuration of the information processing apparatus 10 will be described with reference to FIG. 1. The information processing apparatus 10 includes a controller 11, a memory 12, and a communication interface 13.

The controller 11 includes at least one processor, at least one programmable circuit such as a field-programmable gate array (FPGA), at least one dedicated circuit such as an application specific integrated circuit (ASIC), or any combination thereof. The processor is a general purpose processor such as a central processing unit (CPU) or a graphics processing unit (GPU), or a dedicated processor that is dedicated to specific processing. The controller 11 executes processes related to operations of the information processing apparatus 10 while controlling components of the information processing apparatus 10.

The memory 12 includes at least one semiconductor memory, at least one magnetic memory, at least one optical memory, or any combination thereof. The semiconductor memory is, for example, random access memory (RAM), read only memory (ROM), or flash memory. The RAM is, for example, static random access memory (SRAM) or dynamic random access memory (DRAM). The ROM is, for example, electrically erasable programmable read only memory (EEPROM). The flash memory is, for example, a solid-state drive (SSD). The magnetic memory is, for example, a hard disk drive (HDD). The memory 12 functions as, for example, a main memory, an auxiliary memory, or a cache memory. The memory 12 stores information to be used for the operations of the information processing apparatus 10 and information obtained by the operations of the information processing apparatus 10.

The communication interface 13 includes at least one communication module. Communication modules are, for example, wired LAN (local area network) communication standards such as Ethernet® (Ethernet is a registered trademark in Japan, other countries, or both), wireless LAN communication standards such as IEEE (Institute of Electrical and Electronics Engineers) 802.11, or mobile communication standards such as LTE (Long Term Evolution), 4G (4th generation), or 5G (5th generation) standards. The communication interface 13 receives information to be used for the operations of the information processing apparatus 10, and transmits information obtained by the operations of the information processing apparatus 10. The communication interface 13 enables the information processing apparatus 10 to transmit and receive information to and from other devices via a network.

The network includes the Internet, at least one wide area network (WAN), at least one metropolitan area network (MAN), or a combination thereof. The network may include at least one wireless network, at least one optical network, or a combination thereof. The wireless network is, for example, an ad hoc network, a cellular network, a wireless LAN, or a satellite communication network.

The functions of the information processing apparatus 10 are realized by execution of a program according to the present embodiment by a processor serving as the controller 11. That is, the functions of the information processing apparatus 10 are realized by software. The program causes a computer to execute the operations of the information processing apparatus 10, thereby causing the computer to function as the information processing apparatus 10. That is, the computer executes the operations of the information processing apparatus 10 in accordance with the program to thereby function as the information processing apparatus 10.

The program can be stored on a non-transitory computer readable medium. The non-transitory computer readable medium is, for example, flash memory, a magnetic recording device, an optical disc, a magneto-optical recording medium, or ROM.

Some or all of the functions of the information processing apparatus 10 may be realized by a programmable circuit or a dedicated circuit serving as the controller 11. That is, some or all of the functions of the information processing apparatus 10 may be realized by hardware.

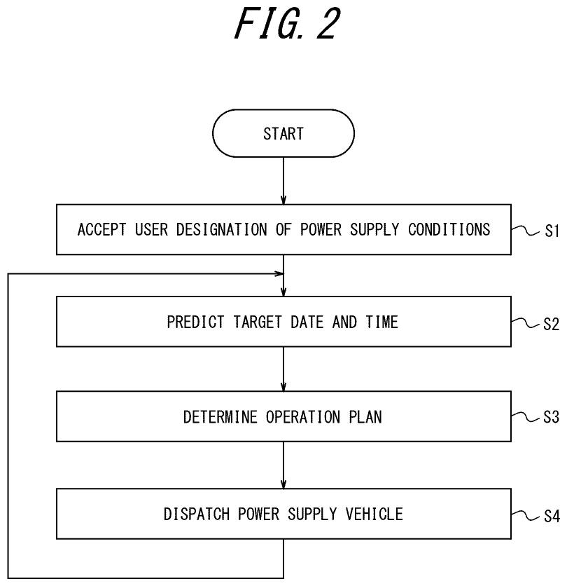

Operations of the information processing apparatus 10 according to the present embodiment will be described with reference to FIG. 2. In the following, communication between the information processing apparatus 10 and external apparatuses is performed via the communication interface 13 and the network. In the following, it is assumed that the controller 11 communicates with respective vehicles of a plurality of users and acquires information indicating the remaining battery capacity from the vehicles at all times.

In S1 of FIG. 2, the controller 11 accepts, from each of the plurality of users, user designation of the power supply conditions when requesting power supply to the vehicle of the user. Specifically, the controller 11 receives from each terminal apparatus the information indicating the user designation of the power supply conditions that each of the plurality of users has entered into their respective terminal apparatus. The power supply conditions include at least one of the following: a first condition designating a range of the remaining battery capacity of the vehicle, a second condition designating a day of week and a time of day, and a third condition designating a power supply location of the power supply vehicle. The range of the remaining battery capacity of the vehicle may be the percentage of remaining capacity relative to the fully charged state of the battery. Multiple days of week and times of day for the second condition may be designated. The time of day may be designated in a predetermined time frame, such as in the morning or afternoon, or every few hours. The power supply location may include the user's address or a location that the user visits in the vehicle, such as his/her place of work.

In this example, a user A enters user designation on the terminal apparatus where the first condition is “equal to or greater than 30% and less than 50%”, the second condition is “10:00 to 16:00 on Wednesday”, and the third condition is “Town B, District A”. A user B enters user designation on the terminal apparatus where the first condition is “equal to or greater than 40% and less than 60%”, the second condition is “10:00 to 12:00 on Saturday and 10:00 to 12:00 on Sunday”, and the third condition is “Town D, District C”. The controller 11 receives information indicating the user designation of the user A and the user B from each terminal apparatus.

In S2, the controller 11 predicts, for each user, the latest date and time at which the power supply conditions pertaining to the user designation are satisfied as the target date and time. For example, the controller 11 first acquires remaining capacity information indicating the estimated future remaining battery capacity of each user's vehicle. Any appropriate method may be employed to acquire the remaining capacity information. For example, the controller 11 may calculate the estimated future remaining battery capacity based on the rate of change in the remaining battery capacity indicated by the information received from each vehicle.

The controller 11 further reads and acquires from the memory 12 schedule information indicating the dates and times when the power supply vehicles can be dispatched. The controller 11 may receive the schedule information from the power supply vehicle. The schedule information may be information indicating the date and time, and the area where the vehicles can be dispatched for each of the plurality of power supply vehicles owned by the operator of the rush power supply service. In this example, the schedule information is assumed to be information indicating the dates and times when the first power supply vehicle and the second power supply vehicle can be dispatched and the areas where they can be dispatched.

Based on the remaining capacity information and the schedule information, the controller 11 predicts the latest date and time that satisfies the first condition to the third condition pertaining to the user designation as the target date and time for dispatching a power supply vehicle to the vehicle of the user. In this example, the controller 11 predicts, based on the remaining capacity information and the schedule information, the latest date and time that is within the range of the remaining battery capacity in the first condition pertaining to the user designation by the user A, that is the day of week and the time of day in the second condition, and at which the power supply vehicle can travel to the power supply location in the third condition, as the target date and time related to the user A. Similarly, the controller 11 predicts, based on the remaining capacity information and the schedule information, the latest date and time that is within the range of the remaining battery capacity in the first condition pertaining to the user designation by the user B, that is the day of week and the time of day in the second condition, and at which the power supply vehicle can travel to the power supply location in the third condition, as the target date and time related to the user B.

In this example, the schedule information would indicate that for the first power supply vehicle, it is available to travel to District A from 12:00 to 17:00 daily, and for the second power supply vehicle, it is available to travel to District C from 8:00 to 17:00 every Saturday and Sunday. Assume that the period of time during which the estimated future remaining battery capacity of the vehicle of the user A is “equal to or greater than 30% and less than 50%”, which is the first condition pertaining to the user designation, is between 10:00 on Monday, April 1 and 14:00 on Wednesday, April 3. The controller 11 predicts the target date and time to be 14:00 on Wednesday, April 3, which is the latest date and time that satisfies the second condition pertaining to the designation by the user A “10:00 to 16:00 on Wednesday” and at which the first power supply vehicle can travel to “Town B, District A”, which is the third condition pertaining to the designation by the user A. It is also assumed that the period of time during which the estimated future remaining battery capacity of the vehicle of the user B is “equal to or greater than 40% and less than 60%”, which is the first condition pertaining to the user designation, is between 12:00 on Saturday, April 6 and 12:00 on Monday, April 8. The controller 11 predicts the target date and time to be 12:00 on Sunday, April 7, which is the latest date and time that satisfies the second condition pertaining to designation by the user B “10:00 to 12:00 on Saturday and 10:00 to 12:00 on Sunday” and at which the second power supply vehicle can travel to “Town D, District C”, which is the third condition pertaining to designation by the user B.

In S3, the controller 11 determines an operation plan. In this example, the controller 11 determines an operation plan in which the first power supply vehicle is dispatched to the user A at 14:00 on Wednesday, April 3, and the second power supply vehicle is dispatched to the user B at 12:00 on Sunday, April 7.

In S4, the controller 11 arranges the power supply vehicle based on the operation plan. For example, the controller 11 transmits information indicating the operation plan to each of the first power supply vehicle and the second power supply vehicle. The first power supply vehicle and the second power supply vehicle may be able to travel to the user by automatic operation based on their respective operation plans.

Thereafter, the processing of the controller 11 returns to S2 each time the power supply by the power supply vehicle is completed with respect to the each of the plurality of users. The controller 11 may acquire information indicating that the power supply has been completed by receiving the information from each power supply vehicle or the vehicle of the user to determine that the power supply by the power supply vehicle has been completed. By repeatedly performing S2 through S4, it is possible to automatically provide power supply services in accordance with the power supply conditions pertaining to the user designation.

As a variation of the present disclosure, the controller 11 may predict, when the power supply location in the third condition pertaining to user designation from each of two or more users among the plurality of users is within the same area, the latest date and time that satisfies the first condition, the second condition, and the third condition pertaining to the user designation from the each of the two or more users as the target date and time. In this case, the controller 11 determines an operation plan for dispatching a power supply vehicle to the two or more users at the target date and time. The range of the same area may be any predetermined range, such as prefecture, city or district.

For example, in S1 above, the controller 11 accepts user designation of power supply conditions for a user C in addition to the user A and the user B above. Assume that the first condition pertaining to user designation by the user C is “equal to or greater than 10% and less than 40%”, the second condition is “8:00 to 13:00 on Monday, 8:00 to 13:00 on Tuesday, and 8:00 to 13:00 on Wednesday”, and the third condition is “Town E, District A”. The controller 11 receives information indicating the user designation of the user C from the terminal apparatus of the user C.

In S2 above, the controller 11 identifies the user A and the user C, among the users A to C, whose power supply locations pertaining to the user designation are within the same “District A”. In this variation, as in the embodiment described above, suppose that the schedule information indicates that for the first power supply vehicle, it is available to travel to District A from 12:00 to 17:00 daily, and that for the second power supply vehicle, it is available to travel to District C from 8:00 to 17:00 every Saturday and Sunday. The controller 11 acquires the remaining capacity information for the vehicles of the user A and the user B as described above, and also acquires the remaining capacity information for the vehicle of the user C. In this variation, assume that the period of time during which the estimated future remaining battery capacity of the vehicle of the user C is “equal to or greater than 10% and less than 40%”, which is the first condition pertaining to the user designation, is between 10:00 on Monday, April 1 and 10:00 on Friday, April 5. In this case, the controller 11 predicts the target date and time to be 13:00 on Wednesday, April 3, which is the latest date and time that satisfies each of the second condition pertaining to the user designation by the user A “10:00 to 16:00 on Wednesday” and the second condition pertaining to the user designation by the user C “8:00 to 13:00 on Monday, 8:00 to 13:00 on Tuesday, and 8:00 to 13:00 on Wednesday”, and at which the first power supply vehicle can travel to “Area A”, which is the area in the third condition pertaining to the user designation by both of the user A and the user C. Then, in S3 above, the controller 11 determines an operation plan to dispatch the first power supply vehicle to the user A and the user C at 13:00 on Wednesday, April 3. In this case, the controller 11 may determine an operation plan that prioritizes travel to the vehicle with the lower estimated remaining battery capacity as of the target date and time among the vehicles of the user A and the user C, respectively. The controller 11 further determines an operation plan to dispatch the second power supply vehicle to the user B at 12:00 on Sunday, April 7, in the same manner as described above. In S4, the controller 11 arranges the power supply vehicle based on the operation plan, as described above.

According to this variation, the controller 11 can determine an operation plan for dispatching one power supply vehicle to a plurality of users within a predetermined area. This will allow operators providing power supply services to further optimize the dispatch of power supply vehicles as a resource.

The present disclosure is not limited to the embodiment described above. For example, two or more blocks described in the block diagram may be integrated, or a block may be divided. Instead of executing two or more steps described in the flowchart in chronological order in accordance with the description, the steps may be executed in parallel or in a different order according to the processing capability of the apparatus that executes each step, or as required. Other modifications can be made without departing from the spirit of the present disclosure.

1. A method performed by an information processing apparatus, the information processing apparatus being used for providing a rush power supply service that dispatches a power supply vehicle to supply power to a vehicle of a user, the method comprising:
accepting, from each of a plurality of users, user designation of one or more power supply conditions for requesting power supply to the vehicle;
performing processing that includes a prediction step of predicting a date and time at which the one or more power supply conditions pertaining to the user designation are satisfied as a target date and time and a determination step of determining an operation plan for dispatching the power supply vehicle at the target date and time; and
repeatedly performing the processing each time the power supply to the vehicle is completed, with respect to the each of the plurality of users.

2. The method according to claim 1, wherein the one or more power supply conditions include a first condition designating a range of a remaining battery capacity of the vehicle and a second condition designating a day of week and a time of day.

3. The method according to claim 2, wherein the prediction step includes a step of acquiring remaining capacity information indicating an estimated future remaining battery capacity of the vehicle and predicting, based on the remaining capacity information, a latest date and time at which the first condition and the second condition pertaining to the user designation are satisfied as the target date and time.

4. The method according to claim 2, wherein
the one or more power supply conditions further include a third condition designating a power supply location for the power supply vehicle, and
the prediction step includes a step of acquiring remaining capacity information indicating an estimated future remaining battery capacity of the vehicle and schedule information indicating a date and time at which the power supply vehicle can travel, and predicting, based on the remaining capacity information and the schedule information, a latest date and time at which the first condition, the second condition, and the third condition pertaining to the user designation are satisfied as the target date and time.

5. The method according to claim 4, wherein
the prediction step includes a step of predicting, in a case in which the power supply location in the third condition pertaining to user designation from each of two or more users among the plurality of users is within a same area, a latest date and time at which the first condition, the second condition, and the third condition pertaining to the user designation from the each of the two or more users are satisfied as the target date and time, and
the determination step includes a step of determining the operation plan for dispatching the power supply vehicle at the target date and time for the two or more users.
